(19) United States
(12) Patent Application Publication
(10) Pub. No.: US 2008/0295340 A1
(43) Pub. Date: Dec. 4, 2008

(54) FREE PIVOTING CUTTING HEAD AND BLADE ASSEMBLY FOR HAIR CUTTER

(76) Inventors: VITO JAMES CARLUCCI, Stratford, CT (US); Harold Roy Taylor, Stratford, CT (US); Robert E. Gaines, Sandy Hook, CT (US)

Correspondence Address: Lawrence Cruz;Conair Corporation, One Cummings Point Road, STAMFORD, CT, 06902, US

(21) Appl. No.: 12/126,314

(22) Filed: May 23, 2008

Related U.S. Application Data
(60) Provisional application No. 60/931,952, filed on May 29, 2007.

(51) Int. Cl. B26B 19/04; B26B 19/00

(52) U.S. Cl. 30/199; 30/289

(57) ABSTRACT

A hair cutting device (1) has an electrically motorized blade assembly (4) mounted pivotally for movement in a limited range of motion under a spring bias (16,/17,/18). The blade assembly (4) may be selectively locked to prevent pivoting as desired. One or more comb attachments (12) can be fitted to the blade assembly (4) including novel comb attachments (12) that each have a curved contact surface (13) that is sized and shaped with a curved surface (13) to engage the natural curvature of a user's scalp to optimize correct alignment and spacing of the blade assembly(4) relative to the hair being cut.

### CROSS REFERENCE TO RELATED APPLICATIONS

This application claims the benefit of U.S. Provisional Application Ser. No. 60/931,952 filed May 29, 2007, herein incorporated by reference in its entirety.

### FIELD OF THE INVENTION

The present invention relates to hair cutting appliances and, more particularly, electric motorized cutters such as clippers or trimmers having motorized, moveable blade assemblies.

### BACKGROUND OF THE INVENTION

Various existing hair clippers and hair cutters exist which utilize electrically powered blade assemblies for cutting or trimming hair. Some existing devices have fixed angle blade assemblies where the blade assemblies and thus the cutting angles are fixed relative to the handle of the device. Others have adjustable angle assemblies that are released, moved, and then locked into position. In either type of device, the characteristic of the blade assembly being fixed causes the user to have to manipulate the angle of the handle relative to the body surface from which hair is being cut in order to accommodate contours of the body surface for achieving optimum cutting angles.

### SUMMARY OF THE INVENTION

It is an object of the present invention to provide a hair cutting device of the type described above with means for improving ease of use when cutting along the changing contours of the body surfaces from which hair is being cut. These and other objects are achieved by the present invention.

According to the present invention, a hair cutting device has an electrically motorized blade assembly mounted pivotally for movement in a limited range of motion under a spring bias. The blade assembly may be selectively locked to prevent pivoting as desired. One or more comb attachments can be fitted to the blade assembly including novel comb attachments that each have a curved contact surface that is sized and shaped with a curved surface to engage the natural curvature of a user's scalp to optimize correct alignment and spacing of the blade assembly relative to the hair being cut.

### BRIEF DESCRIPTION OF THE DRAWINGS

FIG. 1 is a perspective view of a hair cutter having a cutting head and blade assembly according to the present invention;

FIG. 2 is a perspective, internal view of a hair cutter having a cutting head and blade assembly according to the present invention;

FIG. 3A is a side, cross-sectional view of a hair cutter having a cutting head and blade assembly according to the present invention;

FIG. 3B is a detailed side, cross-sectional view of a portion of a hair cutter having a cutting head and blade assembly according to the present invention;

FIG. 3C is a detailed side, cross-sectional view of a portion of a hair cutter having a cutting head and blade assembly according to the present invention;

FIG. 4A is a side, partial cross-sectional view of a hair cutter having a cutting head and blade assembly according to the present invention;

FIG. 4B is a detailed side, partial cross-sectional view of a hair cutter having a cutting head and blade assembly according to the present invention;

FIG. 5 is a side view of a portion of a hair cutter having a cutting head and blade assembly according to the present invention;

FIG. 6 is a side view of a portion of a hair cutter having a cutting head and blade assembly according to the present invention;

FIG. 7 is a top, sectional view of a portion of a hair cutter having a cutting head and blade assembly according to the present invention;

FIG. 8 is a bottom, partial sectional view of a portion of a hair cutter having a cutting head and blade assembly according to the present invention;

FIG. 9A is a partial, top sectional view of a portion of a hair cutter having a cutting head and blade assembly according to the present invention;

FIG. 9B is a partial, top sectional view of a portion of a hair cutter having a cutting head and blade assembly according to the present invention;

FIG. 9C is a partial, side sectional view of a portion of a hair cutter having a cutting head and blade assembly according to the present invention;

FIG. 10A is a top view of a first comb attachment used with a hair cutter having a cutting head and blade assembly according to the present invention;

FIG. 10B is a side view of a first comb attachment used with a hair cutter having a cutting head and blade assembly according to the present invention;

FIG. 11A is a top view of a second comb attachment used with a hair cutter having a cutting head and blade assembly according to the present invention;

FIG. 11B is a side view of a second comb attachment used with a hair cutter having a cutting head and blade assembly according to the present invention;

FIG. 12A is a top view of a third comb attachment used with a hair cutter having a cutting head and blade assembly according to the present invention;

FIG. 12B is a side view of a third comb attachment used with a hair cutter having a cutting head and blade assembly according to the present invention;

FIG. 13A is a top view of a fourth comb attachment used with a hair cutter having a cutting head and blade assembly according to the present invention;

FIG. 13B is a side view of a fourth comb attachment used with a hair cutter having a cutting head and blade assembly according to the present invention;

FIG. 14A is a top view of a fifth comb attachment used with a hair cutter having a cutting head and blade assembly according to the present invention;

FIG. 14B is a side view of a fifth comb attachment used with a hair cutter having a cutting head and blade assembly according to the present invention;

FIG. 15A is a top view of a sixth comb attachment used with a hair cutter having a cutting head and blade assembly according to the present invention;

FIG. 15B is a side view of a sixth comb attachment used with a hair cutter having a cutting head and blade assembly according to the present invention;

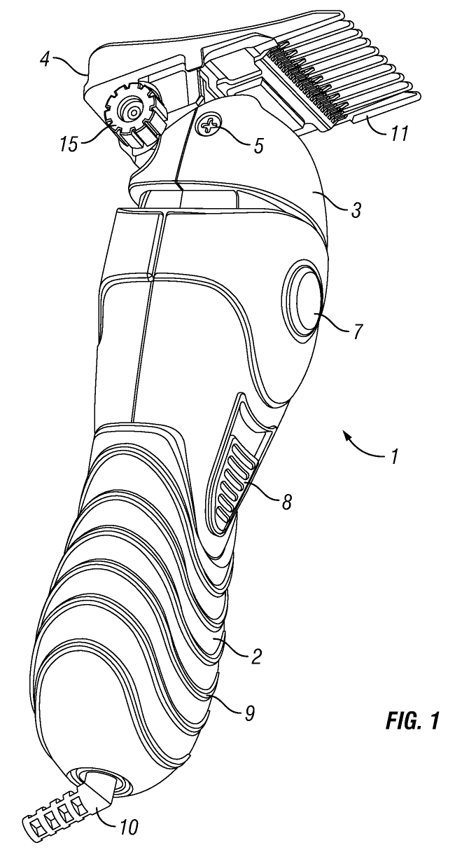

### DETAILED DESCRIPTION OF THE PREFERRED EMBODIMENTS

Referring to the drawing figures, a handheld hair cutting device 1 according to the present invention has a handle portion 2, a distal portion 3, and a blade assembly 4. The blade assembly 4 is pivotally mounted to the distal portion 3 about a first axis defined by a first hinge 5. The distal portion 3 is pivotally mounted to the handle portion 2 about a second axis that is substantially perpendicular to the first axis, the second axis being aligned with an imaginary point 6 shown in FIG. 8. First and second control buttons, 7 and 8, are used to activate pivoting about the second axis 6 and to activate the electric motor. Various control buttons or other input means such as those known to one skilled in the art may be included to control various functions including but not limited to motor and blade speed, timers, locking mechanisms for adjusting portions of components, and other features. A textured gripping area 9 is provided at the proximal end of the handle portion 2 and an electrical cord 10 may be mounted in either fixed or swiveling arrangement.

The blade assembly 4 includes an assembly such as one of various kinds known to one of ordinary skill in the art including but not limited to a pair of cutting plates 11 with teeth where one plate is fixed and the other reciprocates. A comb attachment 12 is provided. While a variety of different types of comb attachments may be provided, a particular novel comb attachment according to the present invention 12 includes a curved contact surface 13, as opposed to a linear contact surface, which fits and moves along the natural curve of the human scalp during use to facilitate pivoting of the blade assembly 4 about the axis 5 during use, as described below. An electric motor 14 is housed in the handle portion 2 and drives the blade cutting plates 11.

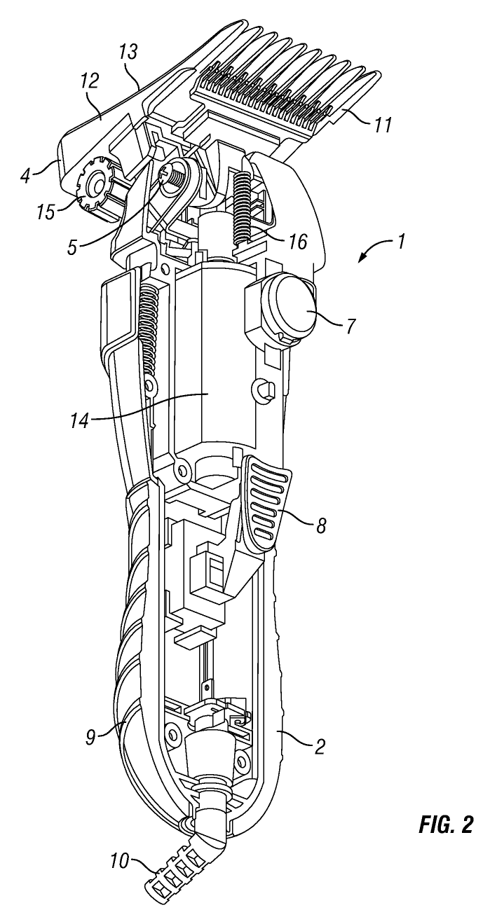

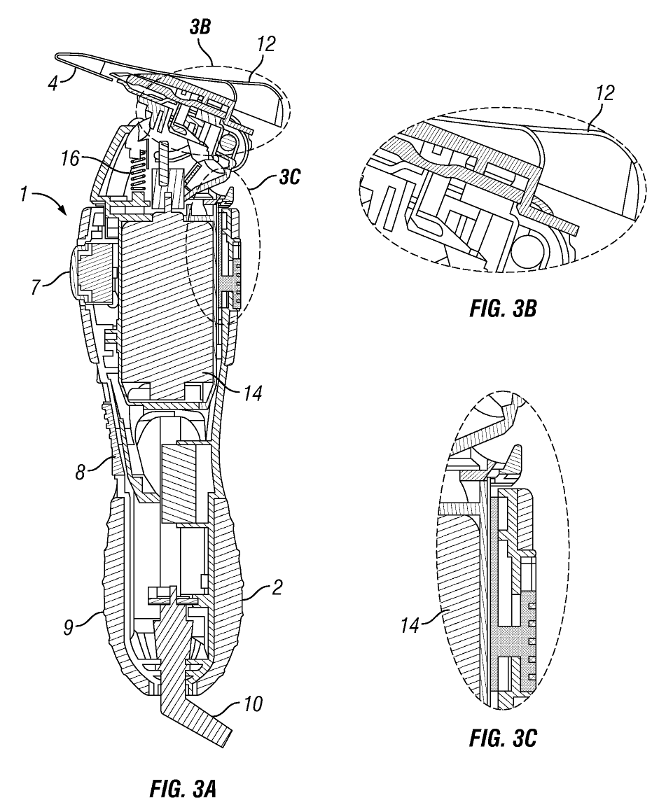

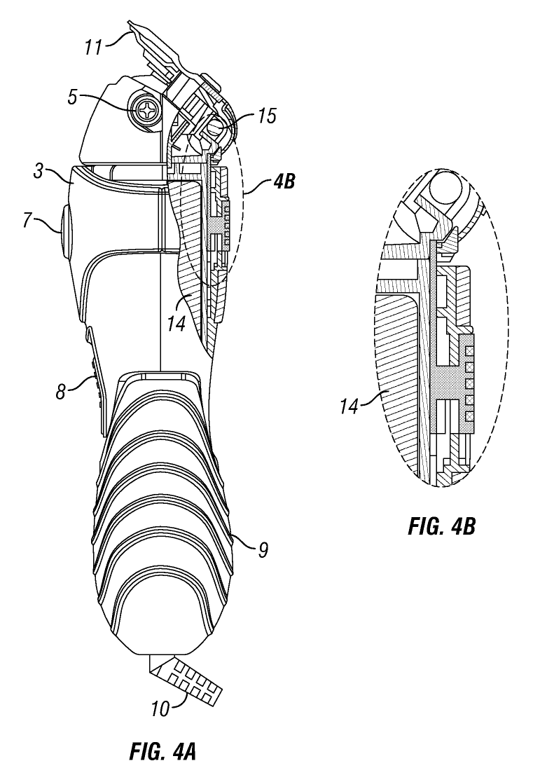

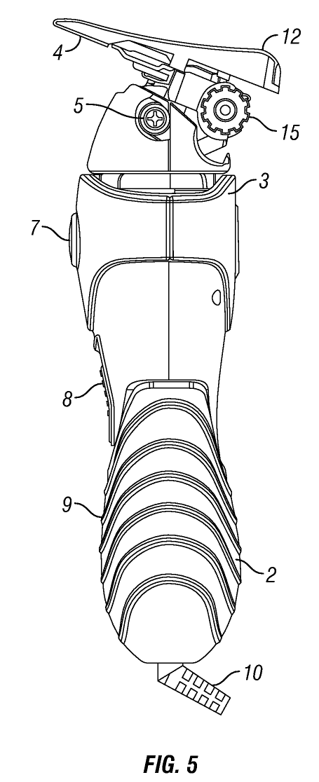

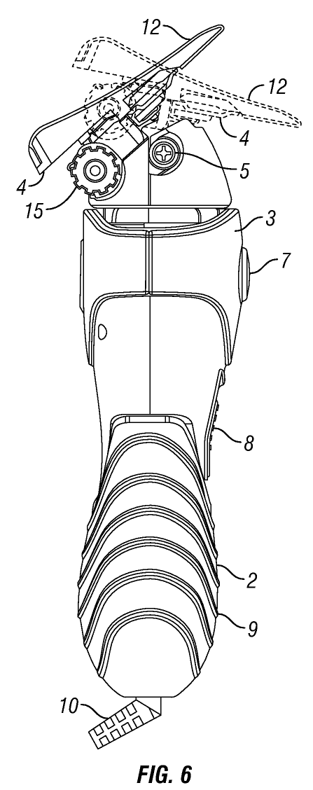

As shown in FIGS. 2, 3A and 6, the blade assembly 4 and the attached comb 12 can pivot about the first axis 5. One or more springs such as a spring 16 are provided to bias the blade assembly 4 to rest at a first, preferably centered, position. The assembly 4 is free to pivot when the comb 12 is engaged with a user's scalp and the device 1 is moved along the scalp, causing the angle of tilt of the assembly 4 with respect to the second, distal portion 3 to vary during use, assuring optimal contact and angle of cut. A tension adjuster or locking mechanism may be selectively activated by control knobs, such as knob 15. As shown in the drawing figures, the knob 15 defines a knurled outer periphery which, upon selective operation by a user, will act to secure the blade assembly 4 from pivoting under the biasing effect of the biasing spring 16.

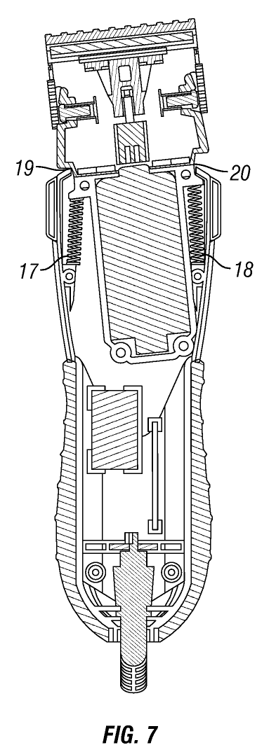

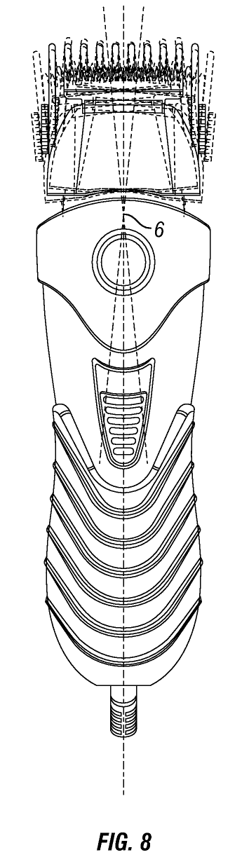

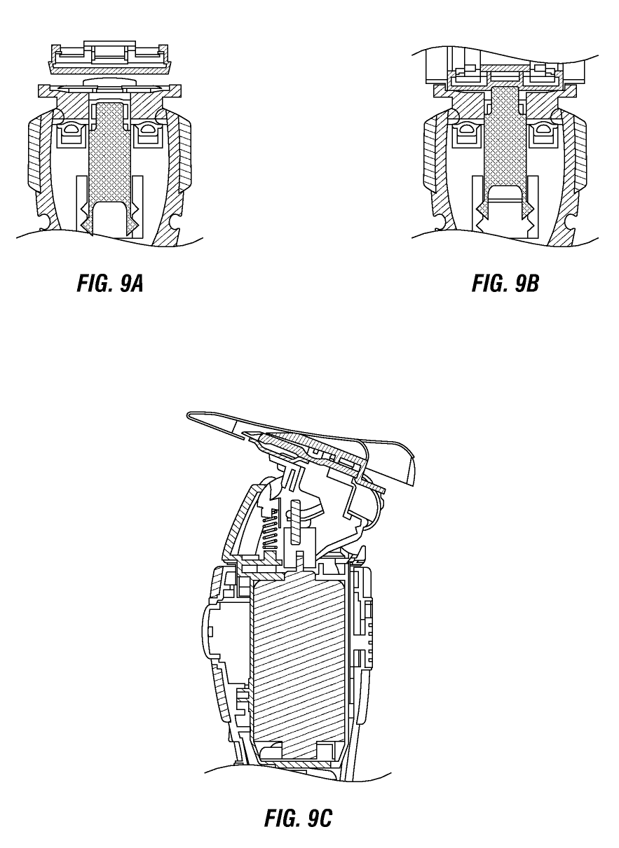

In addition to pivoting about the first axis 5, the assembly 4 also pivots about the second axis 6. Springs 17 and 18 are provided to move the distal portion 3 relative to the handle portion 2. The external diameter 19 of the lower part of the distal portion 3 that is received in the handle portion 2 is less than the internal diameter 20 of the opening of the handle portion 2 within which it is received. Thus, the distal portion 3 may tilt and pivot relative to the handle portion 2, as shown in FIG. 7. A locking mechanism may be added to this aspect as well, so that the distal portion 3 may be locked in one of the tilted positions.

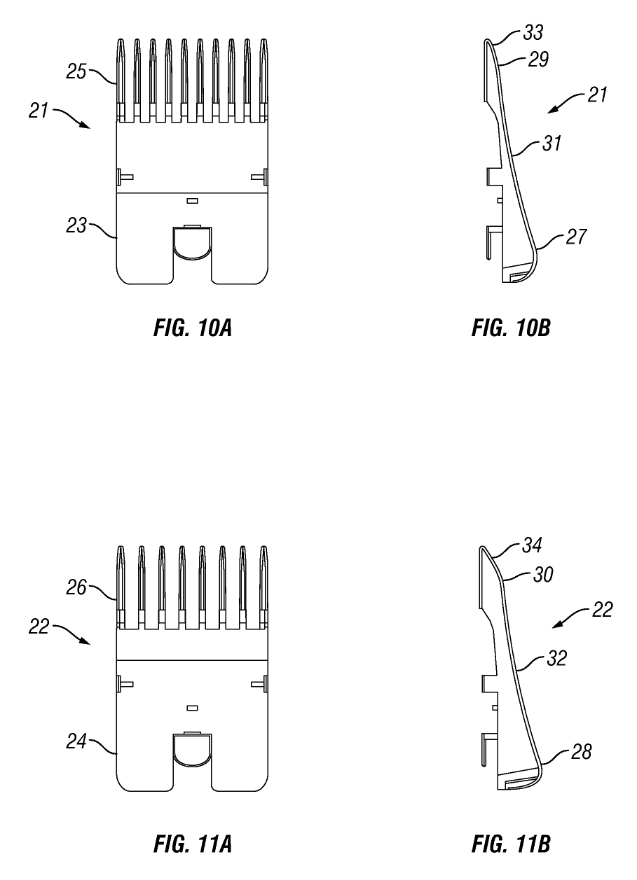

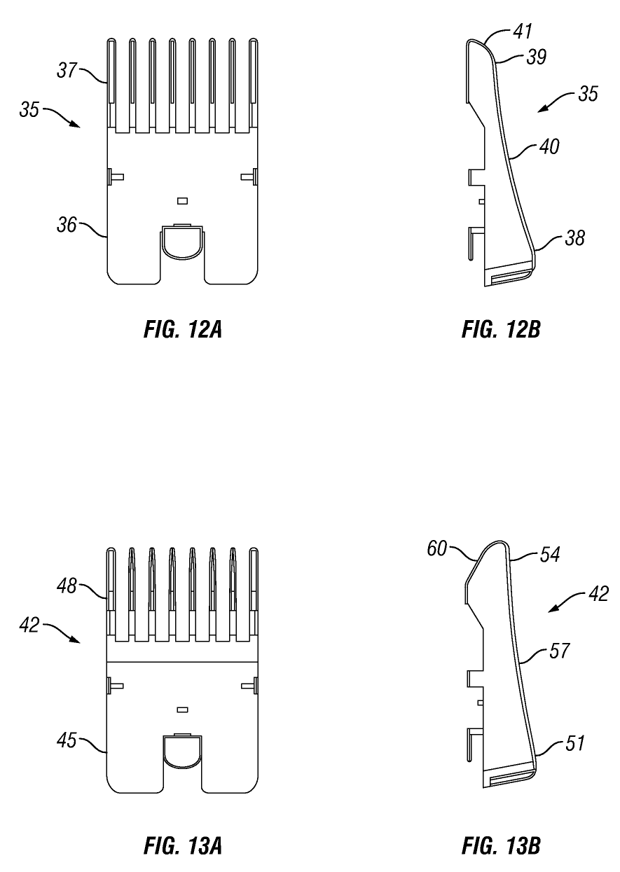

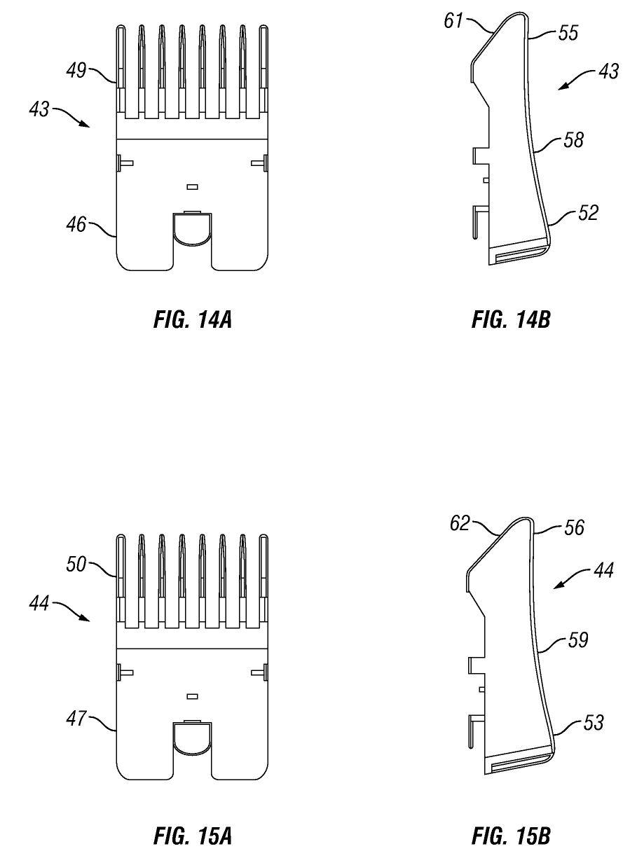

FIGS. 10A-10B through FIGS. 15A-15B are respective top and side views of differently sized and configured comb attachments for use with the device 1 according to the present invention. The comb attachments snap fit onto the blade assembly 4 in a manner known to one skilled in the art.

Referring to FIGS. 10A-10B, FIGS. 11A-11B, and FIGS. 12A-12B, comb attachments 21, 22, 35 each have a base section 23, 24, 36, and a plurality of comb teeth 25, 26, 37. Each tooth of the comb teeth 25, 26, 37 has a heel 27, 28, 38, and a toe 29, 30, 39. The intermediate tooth surface 31, 32, 40 that connects the heels 27, 28, 38 and toes 29, 30, 39 is curved in a substantially concave profile for engaging the shape of a user's scalp. The toes 29, 30, 39 have convexly curved edges 33, 34, 41 of a surface facing the same direction as the intermediate tooth surfaces 31, 32, 40 for optimal hair engagement.

Referring to FIGS. 13A-13B, FIGS. 14A-14B, and FIGS. 15A-15B, comb attachments 42, 43, 44 each have a base section 45, 46, 47 and a plurality of comb teeth 48, 49, 50. Each tooth of the comb teeth 48, 49, 50 has a heel 51, 52, 53 and a toe 54, 55, 56. The intermediate tooth surface 57, 58, 59 that connects the heels 51, 52, 53 and toes 54, 55, 56 is curved in a concave profile for engaging the shape of a user's scalp. The toes 54, 55, 56 have convexly curved edges 60, 61, 62 on a surface facing the opposite direction as the intermediate surfaces 57, 58, 59 for optimal hair engagement, wherein these edges 60, 61, 62 face oppositely compared to the edges 33, 34, 41 because they are attached to combs 42, 43, 44 of a larger size than combs 21, 22, 35.

Thus, the present invention provides a dual-pivoting action to the operative blade assembly 4 of the hair cutting device of the present invention. Indeed, the ability to pivot not only the blade assembly 4 about a first axis, but also having the ability to pivot the entire distal portion 3 about a second, substantially perpendicular axis, gives the hair cutting device 1 of the present invention a range of flexibility and operability not heretofore seen in the art.

Still further, it is another important aspect of the present invention that the base sections of the various comb attachments be formed to evidence a concave profile, thus providing much better and more reliable contact between the base section/comb teeth of the blade assembly 4, and the head or other body portion of a user.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A handheld hair cutting device, comprising:
a handle portion;
a blade assembly operably connected to said handle portion;
a distal portion disposed between and operably connected to said handle portion and said blade assembly;
wherein said blade assembly is mounted to said distal portion for pivotable movement about a first axis; and
wherein said distal portion is mounted to said handle portion for pivotable movement about a second axis, said second axis being substantially perpendicular to said first axis.

2. The handheld hair cutting device according to claim 1, further comprising:
a first biasing means for selectively effecting said pivotable movement of said blade assembly with respect to said distal portion; and
a second biasing means for selectively effecting said pivotable movement of said distal portion with respect to said handle portion.

3. The handheld hair cutting device according to claim 2, wherein:
said first biasing means and said second biasing means each include a biasing spring.

4. The handheld hair cutting device according to claim 2, wherein:
said second biasing means includes a pair biasing springs oriented within said handle portion, each of said pair of biasing springs being disposed on opposing sides of said second axis.

5. The handheld hair cutting device according to claim 1, further comprising:
a textured gripping area defined on said handle portion.

6. The handheld hair cutting device according to claim 1, further comprising:
a locking mechanism to selectively lock said distal portion and said blade assembly in a fixed position.

7. A comb attachment for use with a handheld hair cutting device, comprising:
a base section configured for releasably attaching said comb attachment to said hair cutting device;
a plurality of comb teeth extending from said base section;
wherein said plurality of comb teeth each have an intermediate tooth surface extending from a heel to a toe of each of said comb teeth; and
wherein said intermediate tooth surface defines a substantially concave profile from said heel to said toe.

8. The comb attachment for use with a handheld hair cutting device according to claim 7, wherein:
each of said toes have convexly curved edges.

9. A hair cutting system, comprising:
a handle portion;
a blade assembly operably connected to said handle portion;
a biasing means for permitting a selective pivoting said blade assembly in a first direction and a second direction with respect to said handle portion, said first direction being substantially perpendicular to said second direction;
a comb attachment releasably attached to said blade assembly; and
wherein said comb attachment defines a concave profile.

10. The hair cutting system according to claim 9, wherein:
said biasing means includes a biasing spring.
